(19) United States
(12) Patent Application Publication
(10) Pub. No.: US 2015/0209206 A1
(43) Pub. Date: Jul. 30, 2015

(54) SEAT CUSHION HAVING ADJUSTABLE PRESSURE ZONES

(71) Applicants: Sylvia Joy Bargellini, Oakland, CA (US); Laurel Mooney, Houston, TX (US); C.J. Lopez, Phoenix, AZ (US); Clint Solomon, Morgan Hill, CA (US); Justin Pfledderer, Arlington, TX (US)

(72) Inventors: Sylvia Joy Bargellini, Oakland, CA (US); Laurel Mooney, Houston, TX (US); C.J. Lopez, Phoenix, AZ (US); Clint Solomon, Morgan Hill, CA (US); Justin Pfledderer, Arlington, TX (US)

(21) Appl. No.: 14/584,979

(22) Filed: Dec. 29, 2014

Related U.S. Application Data
(60) Provisional application No. 61/922,934, filed on Jan. 2, 2014.

(51) Int. Cl. A61G 5/10; A61G 7/057

(52) U.S. Cl. CPC A61G 5/1056; A61G 5/1043; A61G 7/05776; A61G 2005/1045

(57) ABSTRACT

A seat cushion having adjustable pressure zones comprises a cushion body having a plurality of pressure control zones, each zone including one or more interconnected inflatable air bladders, each zone of the cushion body is connected to a control component that sends and receives signals to adjust the pressures within maximum and minimum pressure settings.

### BACKGROUND

1. Technical Field

The present disclosure relates, but not limited to medical devices, and in particular to adjustable cushions suitable for use in connection with wheelchairs, the reduction of pressure sores, and the like.

2. Discussion of the Prior Art

Wheelchairs have long been used, for example, in order to improve quality of life for amputees, paraplegics, or those with limited mobility. However, for those who have lost sensation in the lower limbs (such as paraplegics, quadriplegics, and so forth), a major health concern is the development of pressure ulcers. Though there are multiple causes, one of the largest contributors is the lack of blood flow, which is caused by excessive skin pressure for a sustained period of time. Without feeling in the legs, knowing when this is occurring is nearly impossible, so individuals must rely on habit or external help (caregivers) to remember to shift their body weight every so often in order to permit variations in blood flow. As a result, there is an opportunity for improved systems and methods for cushioning, including active and/or adjustable cushions.

### BRIEF DESCRIPTION OF THE DRAWINGS

With reference to the following description, appended claims, and accompanying drawings as attached:

FIG. 1 illustrates a diagram of the full cushion embodiment;

FIG. 2 illustrates the cushion embodiment which includes two main components; the base consisting of an aluminum box containing the controlling electronic components, and the upper cushion consisting of a foam ring and the bladders, which are controlled by the electronic components;

FIG. 3 illustrates an image of a sample set of zones the cushion can have and which bladders the cabling connects to;

FIG. 4 illustrates an embodiment of architecture 1

FIG. 4E illustrates an embodiment of architecture 2

FIG. 4I illustrates a non-exploded embodiment of architecture 3

FIG. 4A-B illustrates the control box of architecture 1 and how it works together with the cushion embodiment.

FIG. 4C-D illustrates the control box of architecture 2 and 3, and what components it is made up of

FIG. 4F illustrates an exploded embodiment of architecture 2 and how the cushion in architecture 2 connects to the control box

FIG. 4G illustrates the tubing placement within the cushion of architecture 2

FIG. 4H illustrates the tubing in architecture 2 connects to the specific zones and how the bladders within the zones connect to each other.

FIG. 4J illustrates an exploded embodiment of architecture 3 and how the cushion in architecture 3 connects to the control box

FIG. 4K illustrates how the tubing placement of the cushion of architecture 3

FIG. 5 illustrates the outer foam ring which surrounds the bladders in all embodiments of the cushion

FIG. 6 illustrates the sensing mechanism utilized in all embodiments of the cushion

### DETAILED DESCRIPTION OF THE ILLUSTRATED EMBODIMENTS

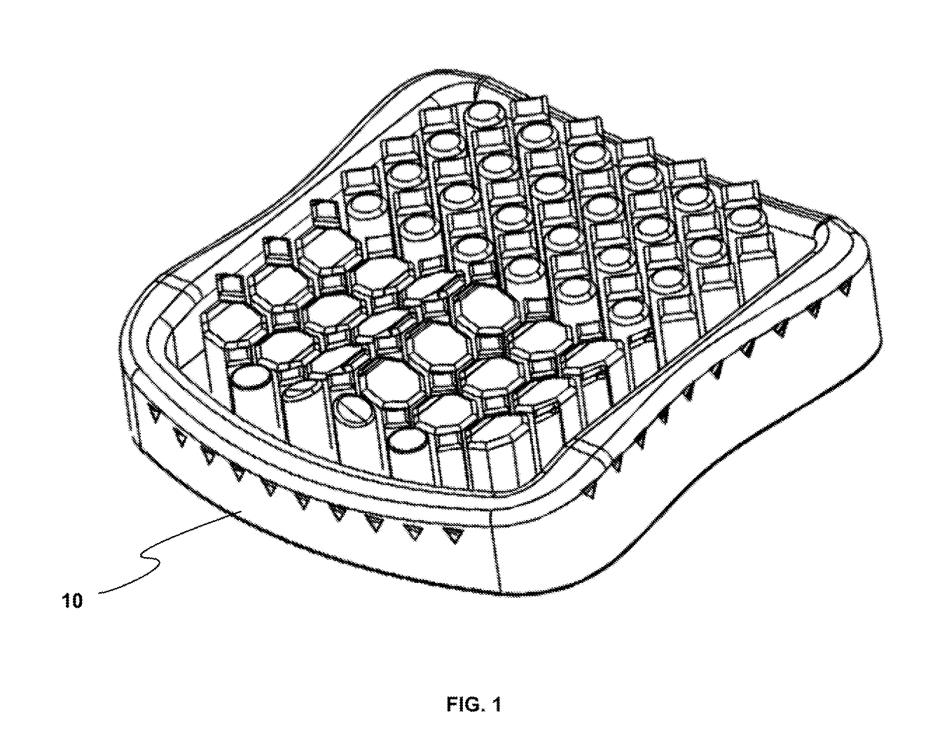

Adjustable cushion system 10 (FIG. 1) is suitable for users in manual or power wheelchairs or even to create cushions for any user sitting in a chair for a long time, eg. pilots, bus drivers, truck driver, etc. It can also be used to create accessories for the back or other parts of the body.

Principles of the present disclosure address at least the following issues for wheelchair users: movement (so the user doesn't have remember), comfort (so the user is comfortable), and appearance because we want the users to be excited about using our product.

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of principles of the present disclosure.

For the sake of brevity, conventional techniques for ergonometric design, cushioning, padding, computer modeling, manufacturing, electronic control, biomechanical activation, and/or well-known physical and mathematical relationships may not be described in detail herein. Furthermore, the connecting lines shown in various figures contained herein are intended to represent exemplary functional relationships and/or physical or communicative couplings between various elements. It should be noted that many alternative or additional functional relationships or physical or communicative connections may be present in a practical adjustable cushion system.

In accordance with principles of the present disclosure, FIG. 1 is an exemplary embodiment of the adjustable cushion system 10.

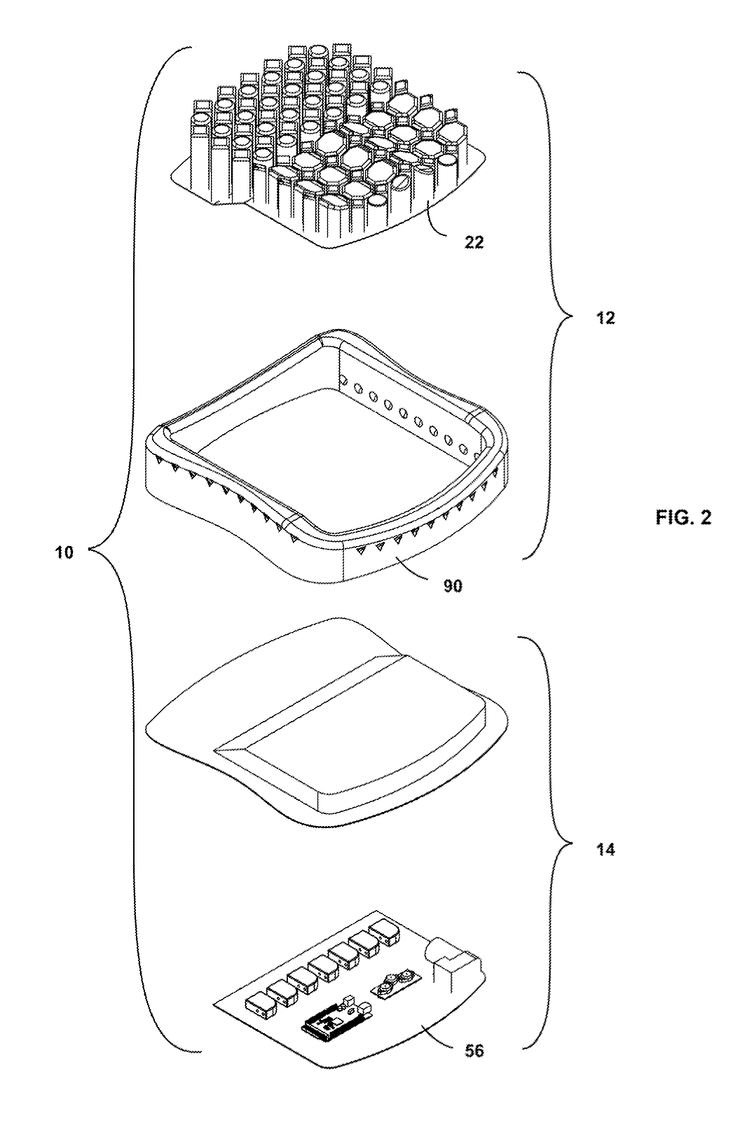

With reference to FIG. 2 the adjustable cushion 10, may comprise of cushion body 12 and control box 14. The cushion body 12 is configured to provide a variable level of support and/or cushioning to a user. Control box 14 is coupled to and controls the cushion body 12 and is configured to characterize, control, interpret, modify, govern, compute, and/or otherwise facilitate operation of cushion body 12. Adjustable cushion system 10 may be independently powered; moreover, adjustable cushion system 10 may utilize external power, for example from a wheelchair battery, a wall socket, and/or other external power sources. In various exemplary embodiments an adjustable cushion system 10 may be operable to vary and/or relieve pressure, for example at a particular point or points on the body of a user such as the back, the head, the arm, the leg, and so forth.

Adjustable cushion system 10 is designed to be modular which makes it easy to take apart, to clean, and to easily replace only one part instead of the whole cushion. This reduces the end waste of partially used cushions that end up in local PVA's or in the dump (because users typically get a new cushion within 3-5 years).

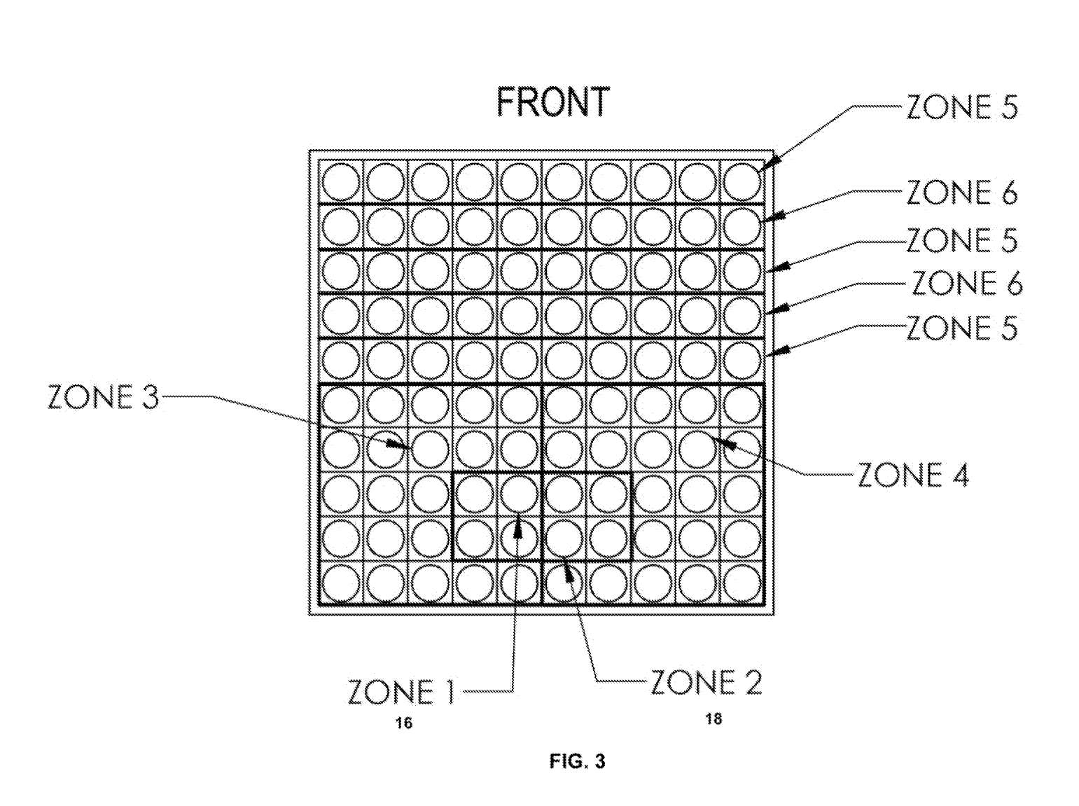

With reference to FIG. 3, in various exemplary embodiments 6 zones are mapped out. Air flows freely between all the bladders within a particular zone utilizing a unique connection system. The smaller zones 16-18 are more focused on the ischial/sacral areas where the most pressure sore problems occur.

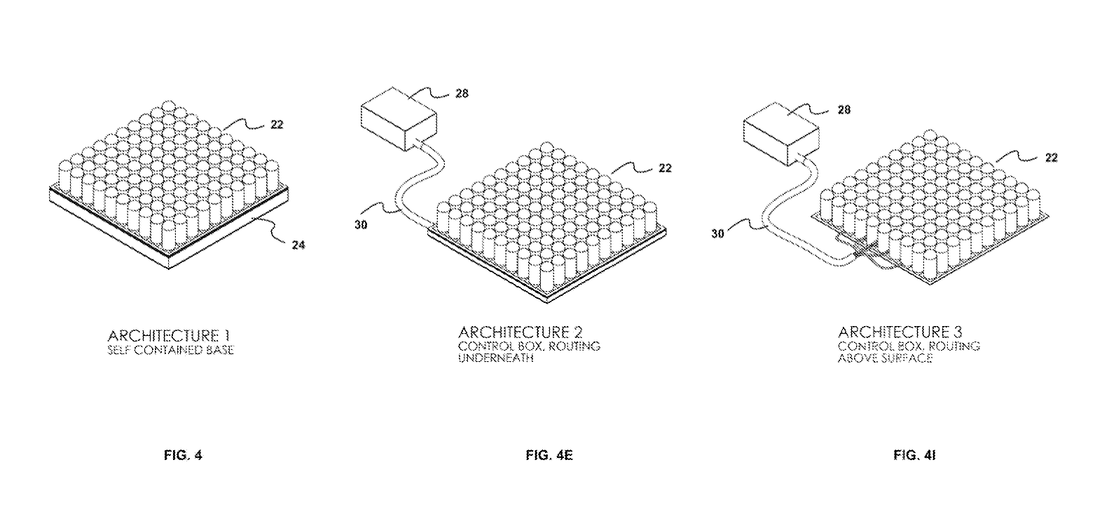

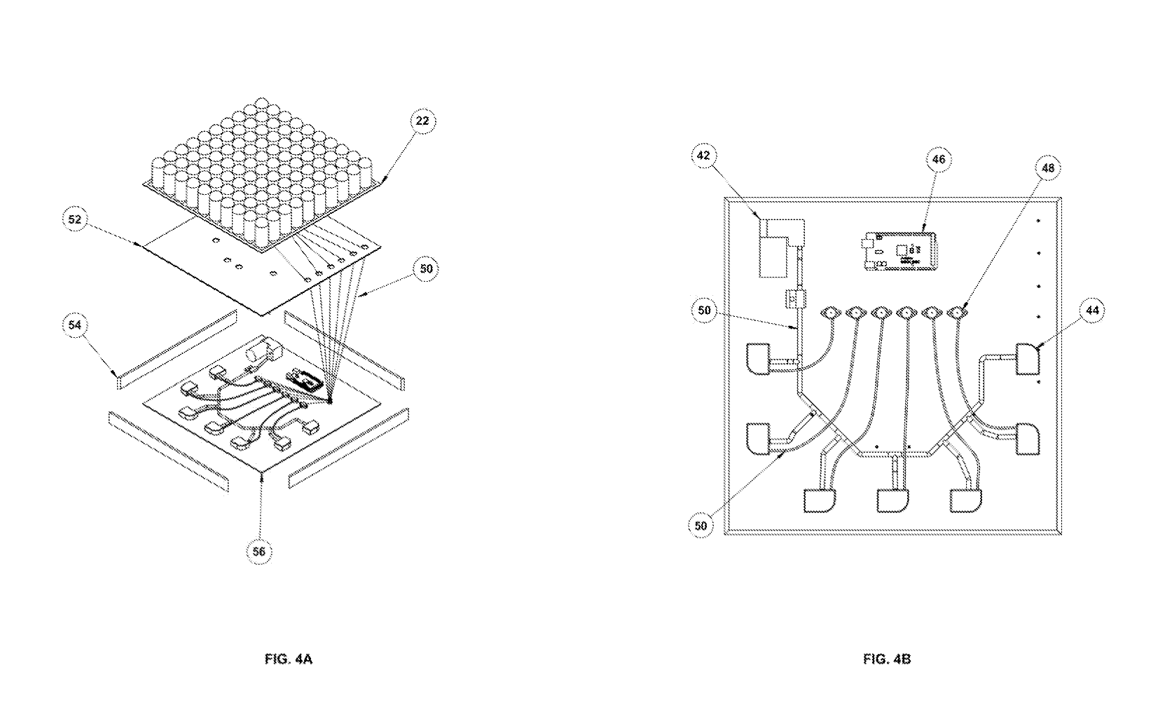

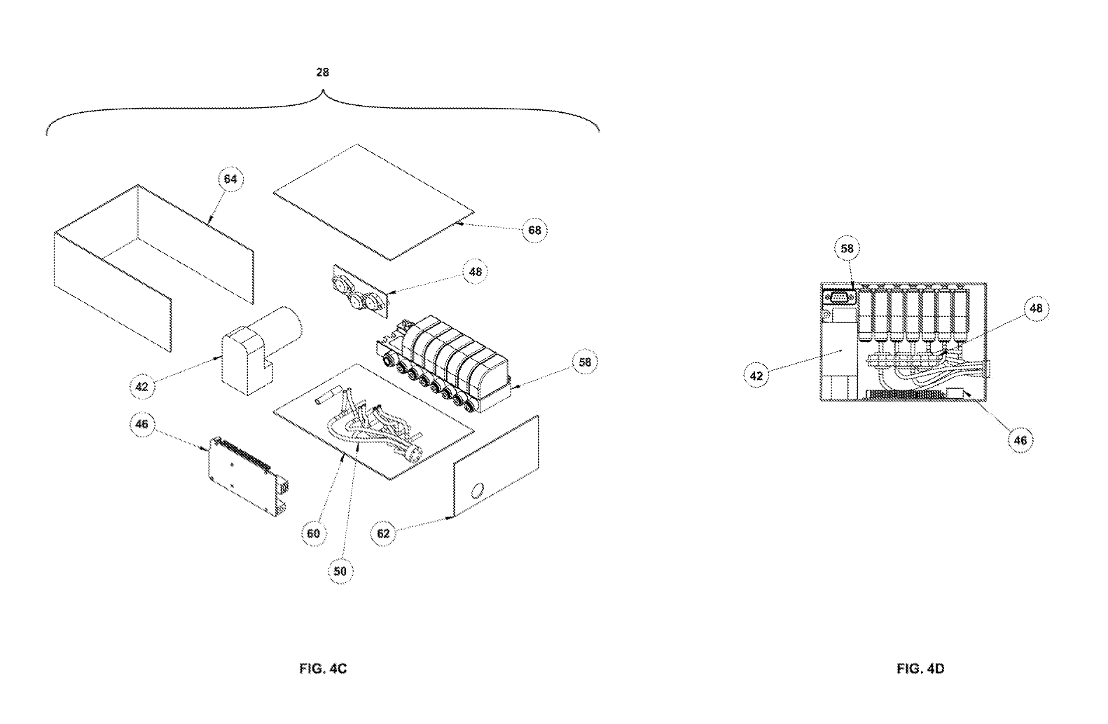

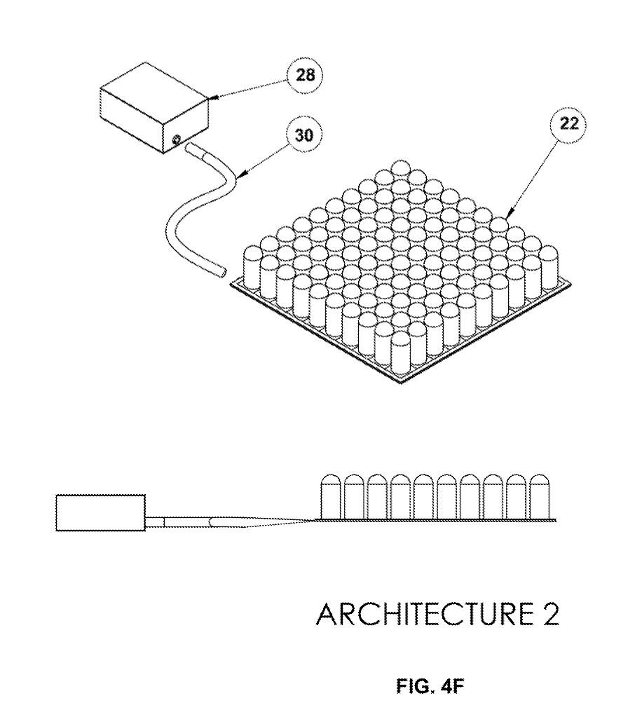

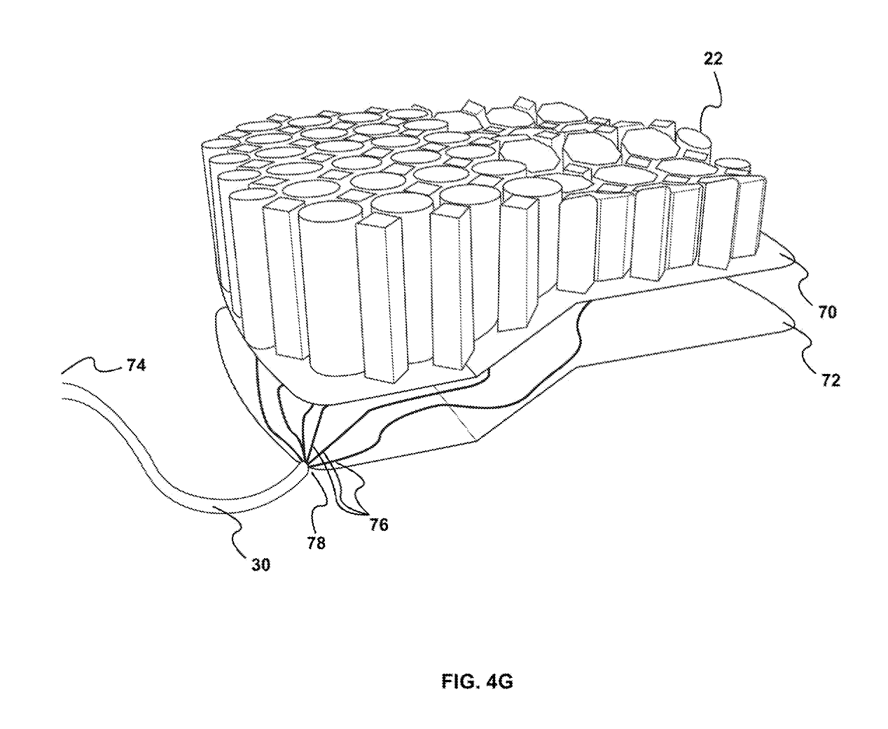

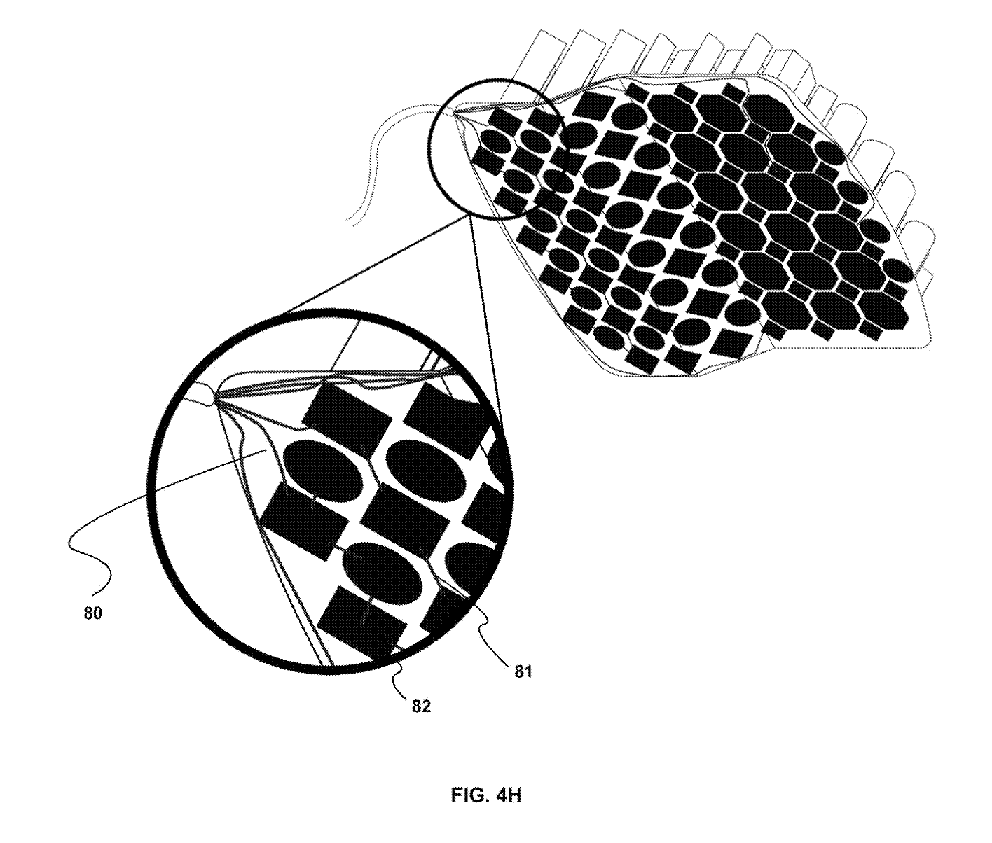

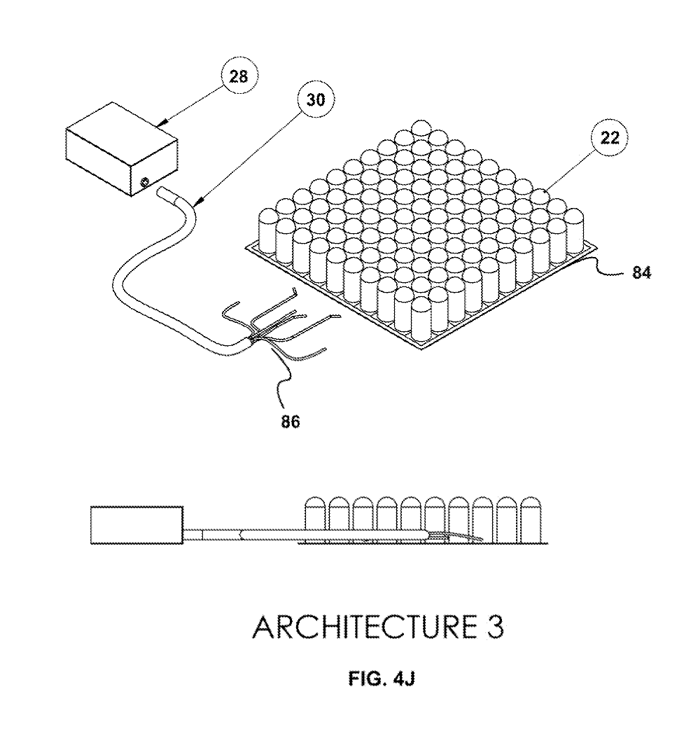

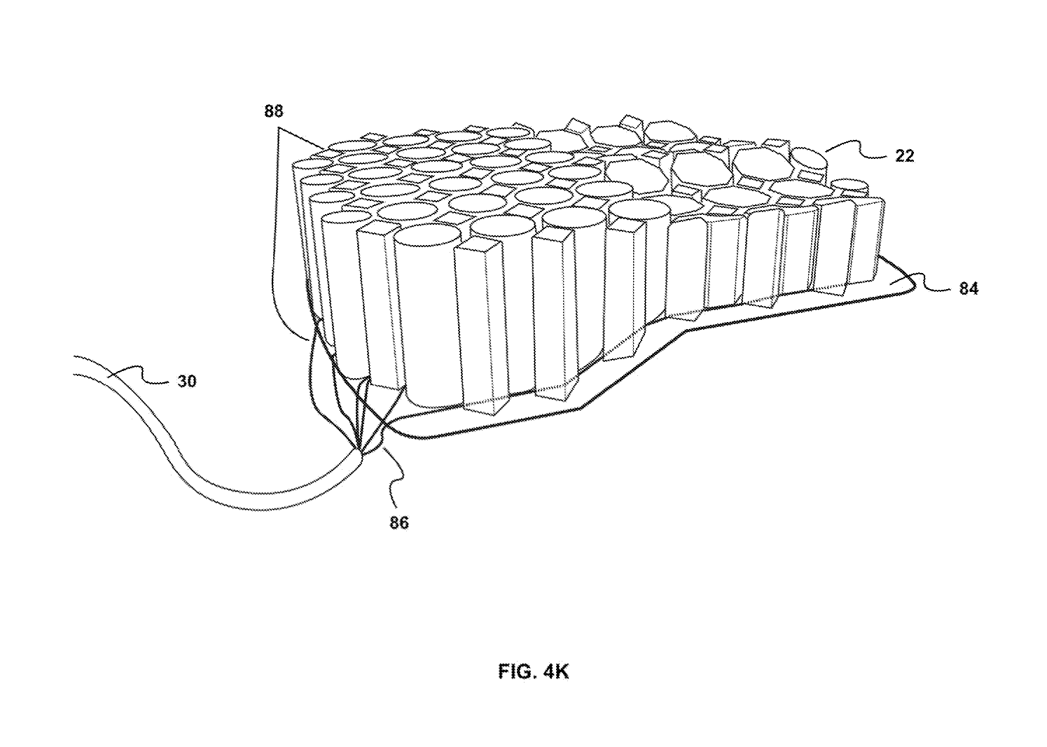

FIG. 4-4K show exemplary product architectures and more detail of these architectures.

FIG. 4 depicts embodiment of architecture 1, which is comprised of bladders 22 which are a schematic representation of the cushion body 12 (FIG. 2) and a base 24, which is a schematic representation of control box 14 (FIG. 2). FIG. 4E depicts architecture 2, which is comprised of a control box 28, connector tubing 30, and bladders 22 that is a schematic representation of the cushion body 12. FIG. 4I depicts architecture 3, which is comprised of a control box 28, connector tubing 30, and bladders 22 that is a schematic representation of the cushion body 12.

Referring to FIGS. 2 and 4-4K, the functional hardware, which makes up the control box 14 (referring to FIG. 2), is nearly identical for the three architectures (FIG. 4-4K), but differ only the existence of a compact manifold (used in Architecture 2, FIG. 4E-H, and Architecture 3, FIG. 4I-K) and in the placement of components. Please refer to FIG. 4B-4D for schematic representations of where the hardware is located. Exemplary components and their functions are listed below:

A vacuum pump 42 fills the air bladders.

Solenoid valves 44 open and close the air passages that connect the zones to the air pump and are electronically controlled. The seventh valve is the exhaust valve to relieve excess internal pressure. Any suitable number of solenoid valves may be utilized in order to control pressure.

Manifold 58 allows for a single pump to connect to multiple zones, for example 6 different zones. These are only used in Architecture 2 (FIG. 4E-H) and Architecture 3 (FIG. 4I-K).

A Microcontroller 46 (for example, Arduino Mega 2560 or other suitable microcontroller) acts as the brain of the system, determining when to open and close valves and activate the pump based on sensory input.

Pressure transducers 48 sense the internal pressure of each zone with relation to ambient pressure and communicate this information to the microcontroller.

Tubing 50 of different sizes connecting the various components.

FIG. 4A exemplifies a schematic representation of an exploded view of the embodiment of architecture 1 (FIG. 4). Architecture 1 is configured as a self-contained system, which gathers all of the hardware components into an integrated base that is positioned directly beneath the cushion body 12. FIG. 4A includes bladders 22, a base system 24, that includes a base lid 52, four walls 54, and a base 56. Tubing 50 connects the cushion bladders 22 and the base system 24. The bladders 22 in architecture 1 utilizes the same cushion tubing architecture as show in FIGS. 4G and 4H.

Architecture 1 is a self-contained system that protects delicate hardware and circuitry from the elements and other potential damage. This configuration provides room for expansion to accommodate additional solenoid valves, sensors, and other sensitive operational components. The integrated base structure increases the overall weight and adds nearly 2″ to the height of the device.

FIG. 4B exemplifies the base system 24 that encloses the hardware components 42-50, which are the different electronics, mentioned in respect to their layout within Architecture 1.

In architectures 2 and 3 (FIGS. 4E and 4I) there is a separated control box 28. FIGS. 4C and 4D show the control box assembly, where all the sensitive operational components are enclosed in an external control box 28. The control box 28 utilizes the same hardware as architecture 1 (FIG. 4-4B) however adds manifold valves 58. This hardware includes a vacuum pump 42, a micro controller 46, pressure transducer sensors 48, various sized connection tubing 50, manifolds 58, and a box comprising of a base 60, walls 62-64, and a lid 68.

The control box 28 is connected to a wheelchair or otherwise suitably located using a specialized harness not shown.

With reference to FIGS. 4F-H, which depict Architecture 2 (FIG. 4E) in more detail. Architecture 2 includes a control box 28, which controls the cushion body 12, a tubing sleeve 30 containing tubing and the cushion bladders 22. The base of bladders 22 comprises of top thin silicon layer 70, which is an integral part of the cushion bladders form, and bottom thin silicon layer 72. Which are glued together to keep the tubing and air inside the cushion body 12. A control box end 74 of tube sleeve 30, that contains a set of flexible tubes 76, is connected to the control box 28. The cushion end 78 of tube sleeve 30 leads tubes 76 to be captured between layers 70 and 72 where they terminate in a connection to one of the zones 80 of bladders 22.

Each bladder 82 within a specific zone 16-18 (refer to FIG. 3) is connected to each other by tubes/trenches 81, and in turn connected to the first bladder that is connected to tubing 80 running from the control box 28 to the individual zone. Each tube, within tubing sleeve 30, thus can be used to control the pressure in one of the zones.

Referring now to FIGS. 4I-K, in Architecture 3 the bladders 22 are supported on a base 84, comprised of two silicon layers glued together to keep the air in the bladder system. As in Architecture 2, the pressure tubes 86 leading from the control box 28 are protectively enveloped by sleeve 30. Each of the tubes 86 extend from sleeve 30 and snake along the flexible base 84 in between the bottom ends of the bladders 22 until it reaches the first bladder of its specific zone 88.

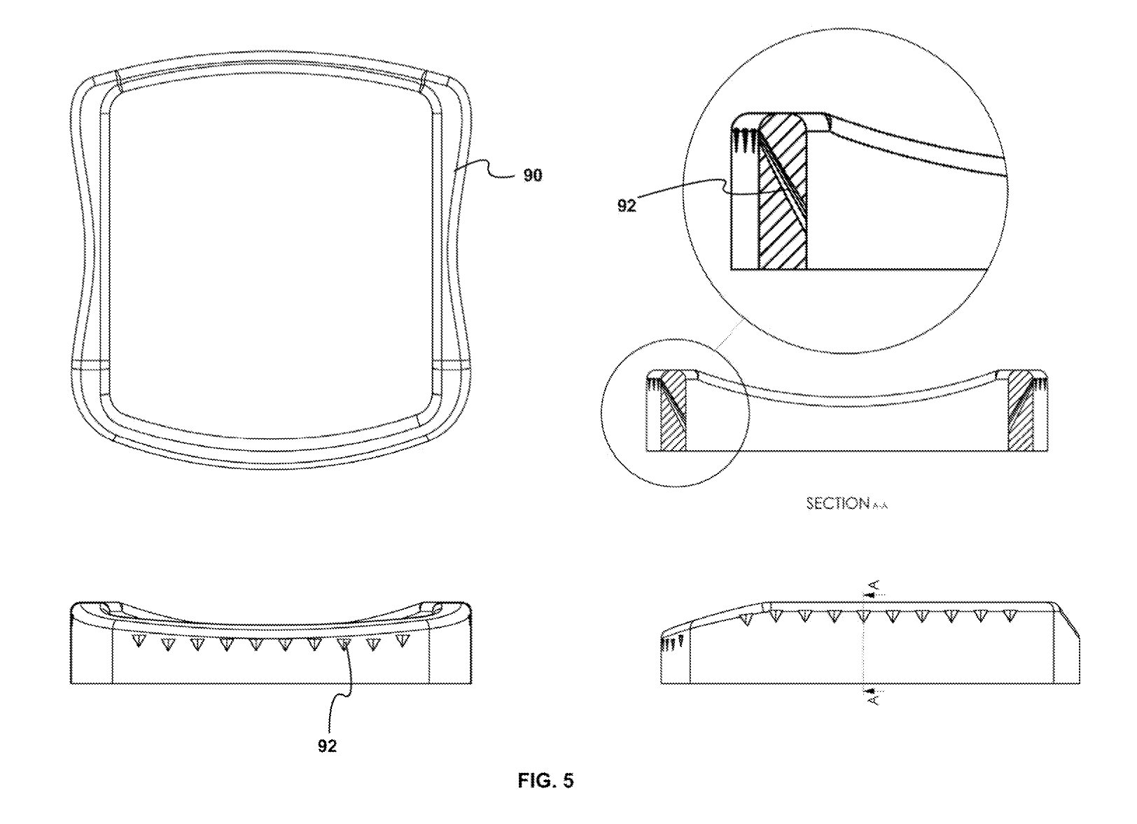

In various exemplary embodiments, adjustable cushion system 10 (FIG. 1), specifically the cushion body 12, utilizes a mix of air bladders and supporting wall 90, as seen in FIG. 5, and does not use a cover. In contrast, prior approaches utilizing covers, particularly the waterproof covers (usually neoprene type) increase humidity and moisture as well as worsen skin sheer.

The supporting wall 90, as seen in FIG. 5, serves multiple purposes. First, it is to make sure that if there happens to be a problem with the air bladders the user does not “bottom out” (has no padding below them). The second is to keep the air bladders together (like a cover might do), and third is to keep any bodily fluids away from the skin but contained inside the adjustable cushion system 10. This supporting wall 90 is made out of self-skinning foam because self-skinning foam is easy to clean (so is the neoprene rubber that the bladders 22 are made of, and the aluminum housing that all architecture embodiments use to encase the control box 14). The fourth purpose is to improve ventilation within the cushion so there is less humidity, moisture and skin sheer.

Adjustable cushion system 10 is configured with ventilation 92, as seen in FIG. 5, by cutting specifically designed holes in the foam of the supporting wall 90. For the ventilation hole design inspiration was found utilizing the idea of biomimicry of gopher holes that are larger farther up, and smaller lower down to effectively pull cool air through the holes and into the cushion area, and hot air away from the user and out of the cushion. With the small movements of the air bladders just enough movement will be created to pull and push air. However, even without movement it will still let air in and out.

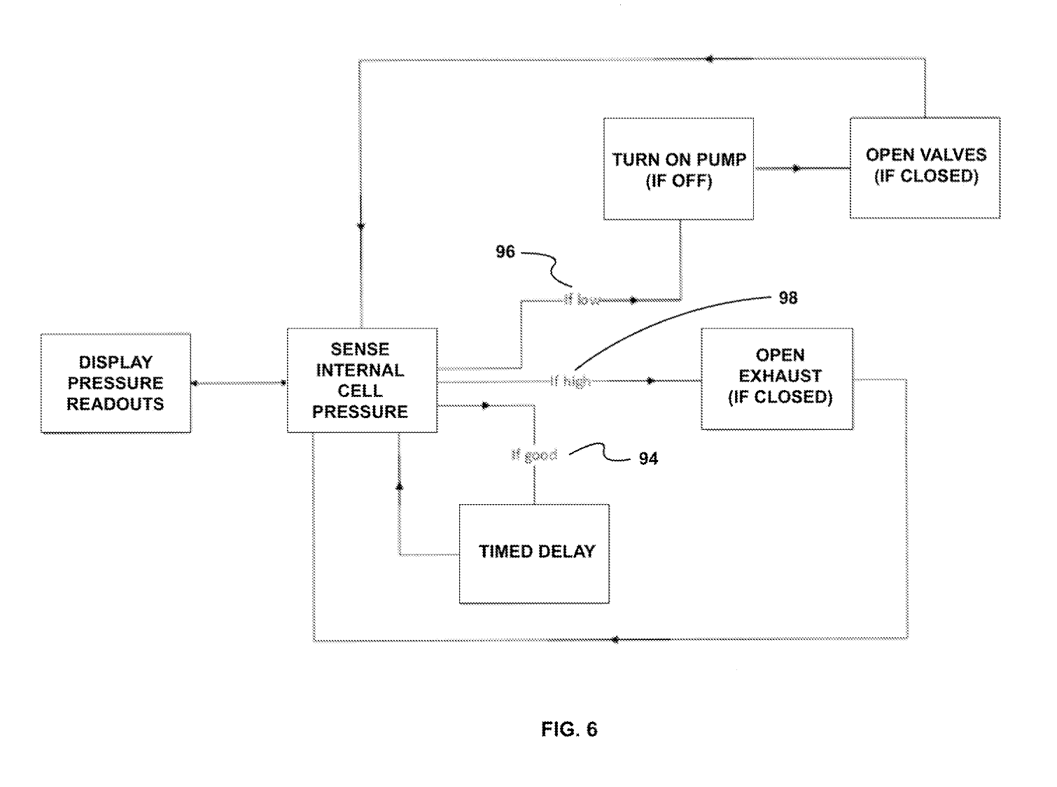

FIG. 6. Illustrates a functional block diagram of operation of adjustable cushion system 10.

Referring to FIG. 6, adjustable cushion system 10 is operable based upon the sensor readings of the internal pressure of each specific zone (FIG. 3) sensed by pressure transducers 48 (4B-4D). As seen in FIG. 6 (with reference to FIG. 4A-4D), if the pressure reading from each zone is “good” 94, there is a timed delay and then the cycle repeats. If the pressure sensors 48 (4B-4D) show the pressure is low 96, in any one or more of the zones, the pump 42 will activate and the corresponding solenoid valves 44 will open to allow air to fill the zones and their corresponding bladders 22. If the sensors 48 show the zones are too high in pressure 98, the appropriate solenoid valves 44 including the exhaust solenoid valve will open to release excess pressure. The internal pressure is continuously checked until all the zones reach safe and set pressure levels (for example between 40-80 mm Hg), at which time the valves 44 will close and the pump 42 will shut off.

Adjustable cushion system 10 may also be configured with a small display to show the user the pressure levels in each of the zones so they are more aware of what their optimal numbers are.

Adjustable cushion system 10, is comprised of multiple independent zones (FIG. 3) which can be set with a high and low psi (each zone may vary in their pressure levels) so that the user and/or a medical professional can customize their cushion. The user does not have to remember to move, because the cushion will relieve pressure in each zone every few minutes. If the user does move, the cushion equalizes all zones' pressures to the user's new position.

For appearance, we utilized all the above mentioned functional parts of adjustable cushion system 10 to create an aesthetically pleasing cushion that users would be excited to use and excited to show off. Instead of hiding the cushion with a cover, and you can see the “inner workings” (the bladders). This adjustable cushion system 10 is to be a useful “accessory,” not just a necessity.

There have thus been described and illustrated certain embodiments of a/an adjustable cushion system 10 according to the invention. Although the present invention has been described and illustrated in detail, it should be clearly understood that the disclosure is illustrative only and is not to be taken as limiting, the spirit and scope of the invention being limited only by the terms of the appended claims and their legal equivalents.

What is claimed is:

1. A seat cushion having adjustable pressure zones comprising:
a cushion body having a plurality of pressure control zones, each zone including one or more interconnected inflatable air bladders,
an air pump operatively connected to each of said plurality of zones,
a plurality of control valves, each of said plurality of control valves disposed between said air pump and one of said plurality of zones,
a plurality of air pressure sensors, each of said plurality of pressure sensors connected to one of said plurality of zones,
memory configured for storing a plurality of predefined minimum and maximum pressure settings, each of said plurality of zones associated with one of said predefined minimum and maximum pressure settings, and
a processor configured for controlling the air pressure in said plurality of zones by
receiving signals from said plurality of air pressure sensors, and
sending signals to said air pump and to said plurality of control valves,
wherein,
when said processor receives a signal from one of said plurality of air pressure sensors indicating that the air pressure in one of said plurality of zones is lower than said minimum pressure setting, said processor sends a signal to the control valve connected to said zone to open and sends a signal to activate said air pump to increase the air pressure in said zone, and
when said processor receives a signal from one of said plurality of air pressure sensors indicating that the air pressure in one of said plurality of zones is higher than said maximum pressure setting, said processor sends a signal to the control valve connected to said zone to open to release air from said zone.

2. The seat cushion of claim 1 wherein:
said processor is configured to control the air pressure in each of said plurality of zones independently from the air pressure in the other of said plurality of zones.

3. The seat cushion of claim 1 further comprising:
a control box having a top plate, said control box enclosing said air pump, said plurality of control valves, said memory, and said processor,
wherein said cushion body is supported by said top plate.

4. The seat cushion of claim 1 further comprising:
a control box housing said air pump, said plurality of control valves, said memory, and said processor, said control box spaced from said cushion body.

5. The seat cushion of claim 4 further comprising:
a plurality of tubes interconnecting said air pump with said plurality of zones.

6. The seat cushion of claim 5 further comprising:
a support base including a top layer and a bottom layer secured to said top layer,
said cushion body supported on said support base,
said plurality of tubes each having a valve end and a zone end, said valve end connected to one of said plurality of control valves, said zone end connected to one of said plurality of pressure control zones, each of the zone ends of said plurality of pressure tubes captured between the top and bottom layers of said support base.

7. The seat cushion of claim 6 further comprising:
a protective sleeve extending between said control box and said support base,
wherein said plurality of pressure tubes is enveloped by said sleeve.

8. The seat cushion of claim 5 further comprising:
said cushion body having a support base, said plurality of zones supported on said base, and
a plurality of pressure tubes each having a valve end and a zone end, said valve end connected to one of said plurality of control valves, said zone end connected to one of said plurality of pressure control zones, a portion of one or more of said tubes snaking between two or more of said plurality of bladders.

9. The seat cushion of claim 8 further comprising:
a protective sleeve extending between said control box and said support base,
wherein said plurality of pressure tubes is enveloped by said sleeve.

10. The seat cushion of claim 1 further comprising:
a flexible perimeter support wall surrounding said cushion body.

11. The seat cushion of claim 10 wherein:
said perimeter wall comprises foam.

12. The seat cushion of claim 11 wherein:
said perimeter wall comprises self-skinning foam.

13. The seat cushion of claim 10 further comprising:
a bottom membrane having a perimeter portion,
said support wall mounted on said perimeter portion such that said support wall and said bottom membrane form a liquid-tight reservoir,
wherein said cushion body is disposed in said reservoir.

14. The seat cushion of claim 10 wherein:
said support wall includes a plurality of ventilation holes, said support wall having an outer surface and an inner surface, said plurality of ventilation holes each having an outer opening in said outer surface and an inner opening in said inner surface, said outer opening higher than said inner opening for exchanging surrounding air with air located between the bladders of said cushion body.

15. A seat cushion having adjustable pressure zones comprising:
a cushion body having a plurality of pressure control zones, each zone including one or more interconnected inflatable air bladders,
a control box having a top plate, said control box enclosing an air pump, a plurality of control valves, memory, and a processor, said cushion body supported by said top plate,
said air pump operatively connected to each of said plurality of zones,
each of said plurality of control valves disposed between said air pump and one of said plurality of zones,
each of said plurality of air pressure sensors connected to one of said plurality of zones,
said memory configured for storing a plurality of predefined minimum and maximum pressure settings, each of said plurality of zones associated with one of said predefined minimum and maximum pressure settings, and
said processor configured for controlling the air pressure in each of said plurality of zones independently from the air pressure in the other of said plurality of zones by
receiving signals from said plurality of air pressure sensors, and
sending signals to said air pump and to said plurality of control valves,
wherein,
when said processor receives a signal from one of said plurality of air pressure sensors indicating that the air pressure in one of said plurality of zones is lower than said minimum pressure setting, said processor sends a signal to the control valve connected to said zone to open and sends a signal to activate said air pump to increase the air pressure in said zone, and
when said processor receives a signal from one of said plurality of air pressure sensors indicating that the air pressure in one of said plurality of zones is higher than said maximum pressure setting, said processor sends a signal to the control valve connected to said zone to open to release air from said zone.

16. A seat cushion having adjustable pressure zones comprising:
a support base support base including a top layer and a bottom layer secured to said top layer,
a cushion body supported on said support base and having a plurality of pressure control zones, each zone including one or more interconnected inflatable air bladders,
a plurality of tubes,
a control box housing an air pump, a plurality of control valves, a plurality of air pressure sensors, memory, and a processor, said control box spaced from said cushion body,
said air pump operatively connected to said plurality of control valves,
each of said plurality of tubes having a valve end and a zone end, said valve end connected to one of said plurality of control valves, said zone end connected to one of said plurality of pressure control zones, each of the zone ends of said plurality of pressure tubes captured between the top and bottom layers of said support base,
each of said plurality of air pressure sensors connected to one of said plurality of zones,
said memory configured for storing a plurality of predefined minimum and maximum pressure settings, each of said plurality of zones associated with one of said predefined minimum and maximum pressure settings, and
said a processor configured for controlling the air pressure in said plurality of zones by
receiving signals from said plurality of air pressure sensors, and
sending signals to said air pump and to said plurality of control valves,
wherein,
when said processor receives a signal from one of said plurality of air pressure sensors indicating that the air pressure in one of said plurality of zones is lower than said minimum pressure setting, said processor sends a signal to the control valve connected to said zone to open and sends a signal to activate said air pump to increase the air pressure in said zone, and
when said processor receives a signal from one of said plurality of air pressure sensors indicating that the air pressure in one of said plurality of zones is higher than said maximum pressure setting, said processor sends a signal to the control valve connected to said zone to open to release air from said zone.
